(19) United States
(12) Patent Application Publication
(10) Pub. No.: US 2006/0251502 A1
(43) Pub. Date: Nov. 9, 2006

(54) Commercial vehicle, especially a truck with a lifting loading platform

(76) Inventor: Kurt Scharfenberger, Ottweller (DE)

Correspondence Address: PLEVY & HOWARD, P.C., P.O. BOX 226, FORT WASHINGTON, PA, 19034, US

(21) Appl. No.: 10/535,869

(22) PCT Filed: Nov. 20, 2003
(86) PCT No.: PCT/DE03/03797

§ 371 Date: Jun. 15, 2006

(30) Foreign Application Priority Data
Nov. 20, 2002 (DE) 10254035.7

(51) Int. Cl. B60P 1/00

(52) U.S. Cl. 414/537

(57) ABSTRACT

The invention relates to a commercial vehicle (1), especially a truck with or without a trailer or semi-trailer, comprising a lifting loading platform which is arranged on the rear end of the vehicle (2) and which can be actuated by means of a control unit (4); also comprising a rear view camera (8) which is arranged behind the rear end of the vehicle (2) and which transmits an image of the monitoring area (9) located behind the rear end of the vehicle (2) to a screen (11) which is arranged in the driver's cabin (7) of the vehicle (1). In order to simplify the alignment of a loading station (13), at least one marking (12) is arranged either in or on the screen (11), said marking being positioned in such a way that the vehicle (1) is placed in a predetermined loading position when a loading station (13), which is associated with the marking (12), is placed next to said vehicle (1) if the marking (2) and a predetermined corner or edge of the loading station (13) associated with the lifting loading platform overlap on the screen. A control unit (4) is also arranged in the driver's cabin (7).

This invention relates to a commercial vehicle, in particular a truck with or without a trailer or semi-trailer.

There are known trucks having a lifting loading platform on a rear end of the vehicle, said platform being operable with the help of an operating unit arranged on this rear end of the vehicle. Such a lifting loading platform is usually adjustable from a closed position, in which it closes the rear end of the vehicle, into a ramp position, in which the lifting loading platform extends essentially horizontally and in which the lifting loading platform lengthens a loading surface of the vehicle toward the rear. Likewise, there are known lifting loading platforms which are additionally or alternatively adjustable into a ground-level position in which they essentially rest flat on a ground area behind the rear end of the vehicle. Lifting loading platforms may be designed directly on the rear end of a truck. It is also possible to design such a lifting loading platform on a trailer or semi-trailer of a truck.

A loading station to be approached by such a truck may be designed, for example, as a loading ramp, which has an end section facing the lifting loading platform onto which the lifting loading platform can be placed in its ramp position. Loading and unloading of the vehicle may then be accomplished especially easily via the ramp and the lifting loading platform.

Other loading stations may be formed, for example, by a ground-level loading surface onto which the lifting loading platform must be lowered.

In order to allow the loading and unloading operation of such a vehicle to be performed, the truck must be brought into a loading position in which the lifting loading platform can be adjusted into its ramp position or its ground position, depending on the loading station. To reach this loading position, the vehicle must be maneuvered to the rear toward the loading station, designed as a loading ramp, for example. This maneuvering operation requires a great deal of experience and care on the part of the driver of the vehicle because optimum positioning of the lifting loading platform on the end section of the loading ramp, so that it is optimum for loading and unloading, is possible only in a predetermined relative position between the vehicle and the ramp (loading position). To reach this predetermined loading position, the vehicle must maintain a relatively narrowly defined distance between the loading ramp and the rear end of the vehicle in order to be able to position the lifting loading platform properly on the end section of the loading ramp. In addition, the loading ramp must be approached in a relatively vertical position in order to avoid oblique or one-sided positioning of the lifting loading platform on the end section of the loading ramp.

To be able to locate this relatively narrowly defined predetermined loading position, after prepositioning the vehicle, the driver of the vehicle, in particular the driver of a vehicle having a trailer or semi-trailer must get out of the vehicle, go to the rear end of the vehicle and evaluate the current position of the rear end of the vehicle. Then the driver of the vehicle must return to the driver's cab to correct the positioning of the vehicle. Next the driver of the vehicle must return to the loading ramp to check on the position again. As soon as the driver of the vehicle has succeeded in positioning the vehicle in the intended loading position—often after repeated corrections—he can then lower the lifting loading platform onto the loading ramp with the help of the operating unit mounted on the rear end of the vehicle. In view of the fact that the main cost factor in shipping goods by truck is the labor time of the driver of the vehicle, there is a need here for saving time in loading and unloading the truck.

To simplify the maneuvering of a commercial vehicle, it is known that a rearview camera may be mounted on the rear end of the vehicle to send an image of a monitoring space behind the rear end of the vehicle to a screen mounted in the driver's cab of the vehicle. With the help of such a rearview camera, the driver of the vehicle can directly observe the space behind the rear end of the vehicle, so that backing up is simplified. Since such a rearview camera must necessarily be provided with a wide-angle lens to be able to include the monitoring space behind the rear end of the vehicle, and since usually only two-dimensional images can be produced by a camera and a display screen, it is difficult for the driver of the vehicle to estimate distances between the rear end of the vehicle and an obstacle the vehicle approaches as it backs up. Accordingly, such a rearview camera can facilitate the initial approach of the vehicle to a loading station, but it still requires the driver of the vehicle to exit from the vehicle to locate the desired loading position in order to be able to perform an on-site evaluation of the current relative position between the rear end of the vehicle and the loading ramp.

The present invention relates to the problem of providing a possibility for simplifying loading and unloading of a commercial vehicle of the type defined in the preamble.

This problem is solved according to this invention by the objects of the independent claims. Advantageous embodiments are the object of the dependent claims.

This invention is based on the general idea of providing a mark in or on the display screen to simplify locating the desired loading position in that the driver of the vehicle maneuvers his vehicle until the mark matches a characteristic corner or edge of the particular loading station on the display screen. As soon as this is the case, the driver of the vehicle may assume that the optimum loading position has been reached, so that the lifting loading platform can be lowered without any additional maneuvering procedure or correction procedure. Since the driver of the vehicle therefore need no longer leave the vehicle to locate the intended optimum loading position, this invention offers a great advantage in terms of time in comparison with traditional trucks.

With this invention, it is a particular advantage that the operating unit of the lifting loading platform is located in the driver's cab. As a result of this measure, additional definite time savings are achieved because the driver of the vehicle now need not leave the driver's cab to operate the lifting loading platform. Since the pivot area of the lifting loading platform is situated completely within the monitoring area covered by the rearview camera, this remote control of the lifting loading platform does not yield any safety concerns because the driver of the vehicle is able to monitor on his display screen whether there is a person or another obstacle within the pivot range of the lifting loading platform.

Since the operating unit is equipped with at least four switches for operating different functions of the lifting loading platform as proposed according to this invention, the operating unit also has a particularly inexpensive design.

In the case of a loading station designed as a loading ramp, the characteristic edge may be formed by an upper front edge of the loading ramp which faces the lifting loading platform, for example. The mark assigned to such a loading ramp is then positioned in or on the display screen in such a way that this front edge on the screen coincides with the respective mark when the commercial vehicle reaches the loading position assigned to this mark; in this position, the lifting loading platform can be positioned reliably on an end section of the loading ramp having the front edge.

In addition or as an alternative to a mark which is assigned to a loading ramp may be provided in or on the display screen; this mark is assigned to a loading station designed as a ground-level loading surface. With such a loading station, the characteristic corner or edge may expediently be formed by a lower edge of a border of the loading surface which protrudes upward from the ground and faces the lifting loading platform. Such a border may be formed, for example, by a stairstep or by the wall of a building. The loading station is then selected so that the lifting loading platform can reliably be placed on the loading surface in front of this border for loading and unloading.

The mark and/or marks provided on the display screen may be applied permanently or adjustably on a display screen housing. It is likewise possible to integrate one or more marks into the image displayed in or on the display screen in a permanent or adjustable manner so that the respective mark becomes a part of the image.

According to another embodiment, a control unit in which a respective mark is or can be stored for each of several different loading stations may also be provided, in which case a mark that has been saved can be called up by input of the desired loading station, which is then displayed on the display screen. With the help of this further embodiment, it is possible to save the respective marks for essentially any number of different loading stations and to display them on the display screen as needed. Essentially any loading station to be approached by the vehicle can be provided with an appropriate mark in this way. Loading stations, in particular loading ramps, may differ from one another by having different ramp heights, for example, thus requiring different loading positions for the vehicle accordingly. Through the assignment of individual marks, locating of the different loading positions can be greatly simplified, in particular in the case of vehicles which regularly travel the same routes.

Other important features and advantages of the invention are derived from the subclaims, the drawings and the respective description of figures with reference to the drawings. It is self-evident that the features mentioned above and those yet to be explained below can be used not only in the combinations given in each case but also in other combinations or even alone without going beyond the scope of the present invention.

Preferred exemplary embodiments of this invention are depicted in the drawings and are explained in greater detail in the following description.

The drawings show schematically

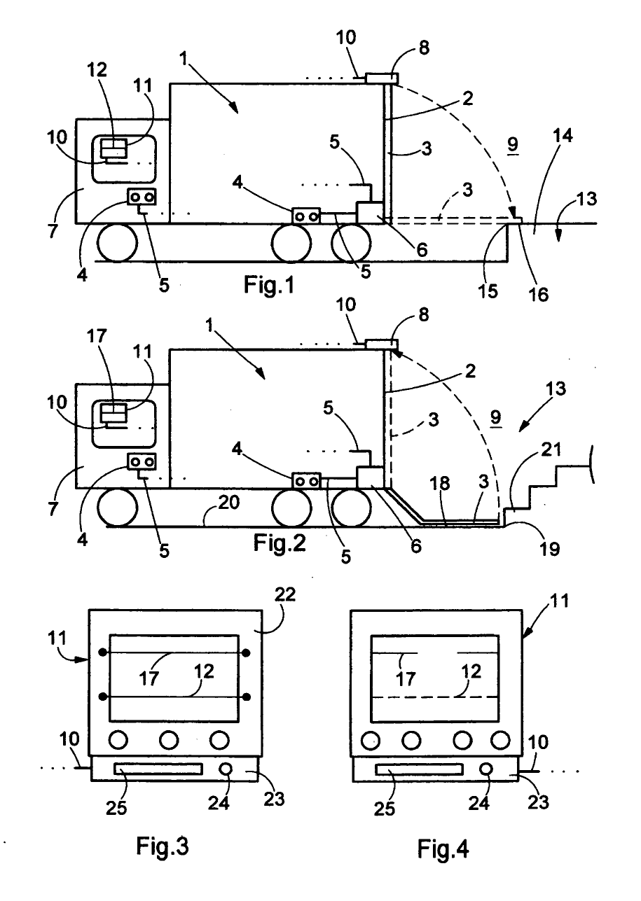

FIG. 1 a side view of a commercial vehicle designed as a truck without a trailer, with a loading station designed as a loading ramp,

FIG. 2 a view like that in FIG. 1, but with a loading station designed as a loading surface,

FIG. 3 a view of a display screen with a mark provided on it in a first embodiment,

FIG. 4 a view like that in FIG. 3, but in a second embodiment,

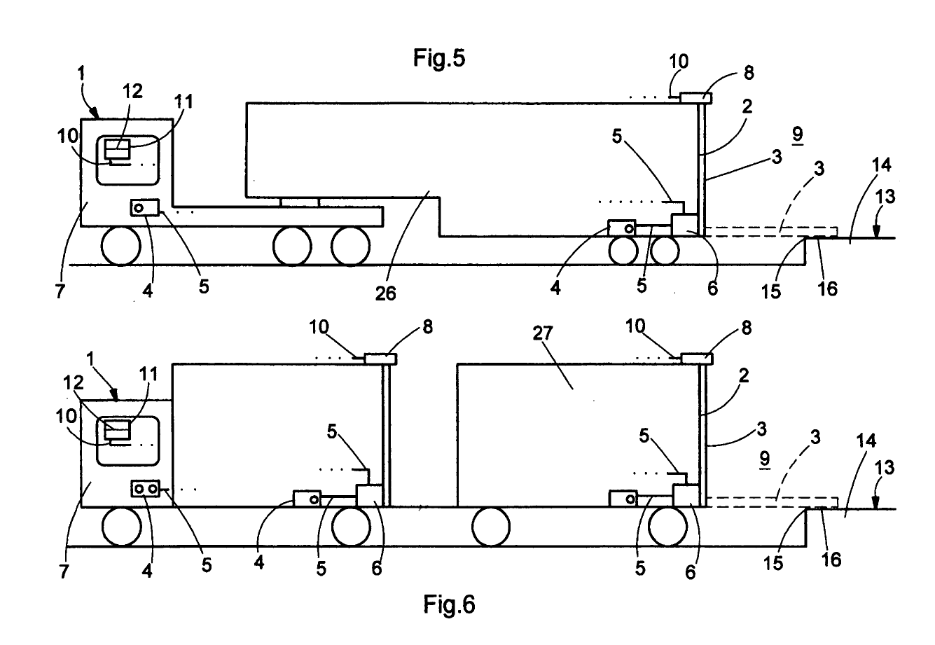

FIG. 5 a view like that in FIG. 1, but with a commercial vehicle designed as a truck with a semi-trailer, and

FIG. 6 a view like that in FIG. 1 but with a commercial vehicle designed as a truck with a trailer,

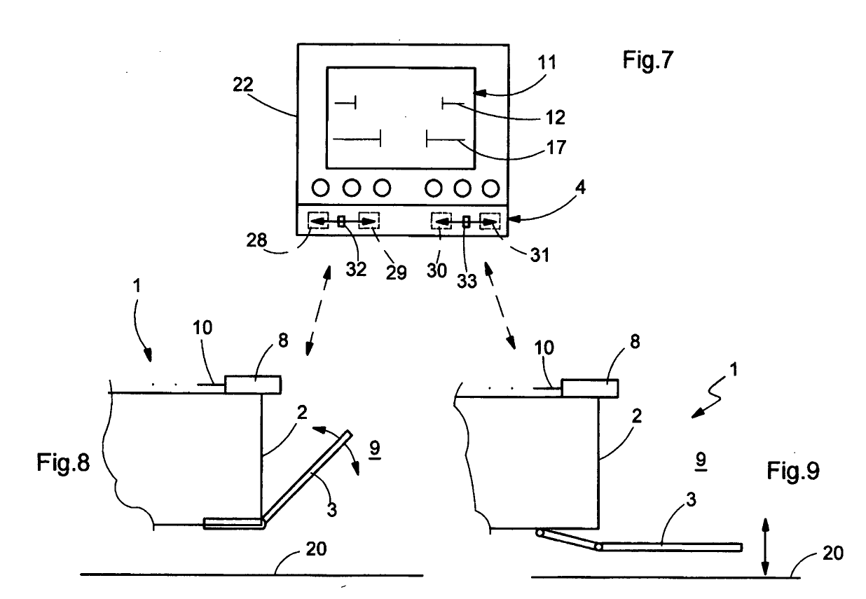

FIG. 7 a view like that in FIG. 3 but with a different embodiment,

FIG. 8 a side view of a rear end area of a commercial vehicle in pivoting and/or pivoting a lifting loading platform,

FIG. 9 a view like that in FIG. 8 but in lowering and/or raising the lifting loading platform.

In the present figures, the same reference numbers refer to the same or functionally identical or similar features.

According to FIG. 1 an inventive commercial vehicle 1, which is designed as a truck without a trailer in the embodiment according to FIG. 1, has a lifting loading platform 3 at the rear end 2 of the vehicle, this lifting loading platform being adjustable at least between a closed position, depicted with solid lines in FIG. 1, and a ramp position, depicted with interrupted lines in FIG. 1. For operating the lifting loading platform 3, at least one operating unit 4 is provided, connected by corresponding lines 5 to a drive unit 6 of the lifting loading platform 3. According to this invention, the operating unit 4 is accommodated in a driver's cab 7 of the vehicle 1 such that a vehicle driver can remain in the driver's cab 7 to operate the lifting loading platform 3. Likewise, an embodiment in which such an operating unit is arranged both in the driver's cab 7 and close to the lifting loading platform 3 in the area of the rear end 2 of the vehicle is possible, so that the lifting loading platform 3 can be operated either from the driver's cab 7 or directly at the lifting loading platform 3.

The inventive commercial vehicle 1 is also equipped with a rearview camera 8 which picks up an image of a monitoring space 9 situated behind the rear end 2 of the vehicle. The rearview camera 8 sends the image signals over corresponding lines 10 to a display screen 11 mounted in the driver's cab 7. The image picked up by the rearview camera 8 can be displayed on this display screen 11, so that the driver of the vehicle can control the monitoring space 9 from the driver's cab 7.

According to this invention, at least one mark 12 is provided in or on the display screen 11 and is depicted here in the form of a horizontal line. This mark 12 is assigned to a predetermined loading station 13 and/or a certain type of loading station. In the case of FIG. 1, this loading station 13 is formed by a loading ramp 14. A predetermined characteristic corner or edge facing the lifting loading platform 3 is now assigned to the mark 12, this corner or edge being formed by an upper front edge 15 in the case of the loading ramp 14 in FIG. 1. The mark 12 is positioned in or on the display screen 11 according to this invention, so that the commercial vehicle 1 has a predetermined loading position assigned to this loading station 13 when this front edge 15 is covered with the mark 12 on the display screen 11; in this position, the lifting loading platform 3 can be opened for an optimum loading and unloading process and/or can be lowered on to the loading ramp 14.

The present invention operates as follows:

When the vehicle 1 is to be brought into its optimum loading position in relation to the loading ramp 14, i.e., optimum for the loading and unloading operation, the driver of the vehicle maneuvers the vehicle 1 so that the vehicle 1 with its rear end 2 of the vehicle slowly approaches the loading ramp 14. As soon as the loading ramp 14 enters the monitoring space 9 of the rearview camera 8, the driver of the vehicle can monitor whether the predetermined loading position has been reached by observing the display screen 11. The driver can maneuver the vehicle 1 by means of the image in the monitor 11 until the front edge 15 of the loading ramp 14 coincides with the mark 12 on the display screen 11. At the same time, the driver can monitor the vertical alignment of the vehicle 1 in relation to the front edge 15. Only when the vehicle 1 approaches the front edge 15 vertically is a parallel alignment achieved with the mark 12, in the form of a horizontal line, and the front edge 15, shown on the display screen 11.

As soon as the front edge 15 and the mark 12 correspond on the display screen 11, the desired loading position for the vehicle 1 in relation to the loading ramp 14 has been reached. The driver of the vehicle can then expediently lower the lifting loading platform 3 with the operating unit 4 arranged in the driver's cab 7, with the platform coming to rest on an end section 16 of the loading ramp 14 having the front edge 15 in a reliable manner, i.e., with a sufficient overlap. This maneuvering process can also be monitored on the display screen 11.

According to FIG. 2, a mark 17 may also be provided on the display screen 11, this mark being assigned to another loading station 13, in this case a ground-level loading surface 18. The characteristic corner or edge of such a loading surface 18 is formed here by a lower edge 19 of a border 21 that protrudes upward from the bottom 20 of the loading surface 18 and faces the lifting loading platform 3. This border 21 of the loading surface 18 is formed in FIG. 2 by the bottom step of a stairstep. The mark 17 assigned to this loading surface 18 is positioned in or on the display screen 11 so that in the respective loading position of the vehicle 1, the lifting loading platform 3 can be positioned reliably in front of this border 21 on the loading surface 18. To this end, the lifting loading platform 3 in FIG. 2 is adjustable into a ground position in which it comes to rest on the ground 20 and/or on the ground-level loading surface 18. With the help of the mark 17, this ensures that there will not be a collision between the lifting loading platform 3 and the border 21 when the lifting loading platform 3 is lowered into its ground position according to FIG. 2.

According to FIGS. 3 and 4, multiple marks 12 and 17, in particular more than two different marks, may be provided in or on the display screen 11.

In the embodiment according to FIG. 3, the marks 12 and 17 are provided on a display screen housing 22. The marks may be permanently provided on the display screen housing 22. It is likewise possible to apply the particular marks 12 or 17 adjustably to the display screen housing 22. For example, an adjustment to a certain loading station 13 may therefore be performed individually.

Instead of providing the marks 12 and 17 on the display screen housing 22, the marks may also be applied to the display screen surface, for example, e.g., by gluing or painting them on the surface.

In the embodiment according to FIG. 4, the marks 12 and 17 are integrated into the image shown on the display screen 11. This means that the marks 12 and 17 form a part of the image displayed on the display screen 11. In this embodiment, adjustability or variability of the respective marks 12 or 17 can be achieved especially easily. In this way, a precision adjustment of the respective marks 12 or 17 for adaptation of the vehicle 1 to a certain loading station 13 can also be performed.

Although the marks 12 and 17 are formed by continuous horizontal lines or bars in the embodiment according to FIG. 3, the linear marks 12 and 17 in the embodiment according to FIG. 4 are formed by interrupted lines, which ensures that the characteristic edge 15 and/or 19 for the respective loading station 13 can be discerned especially well on the display screen 11 in the interruptions in the marks 12, 17.

According to FIGS. 3 and 4, a control unit 23 may also be provided with this invention; with the help of this control unit, a respective mark 12, 17 can be stored for each of several different loading stations 13. For example, in a memory mode of the control unit 23, a certain loading station 13 can be approached in a traditional manner, e.g., with a guide. As soon as the desired loading position has been reached, a corresponding mark may be made on the display screen 11 and assigned and then stored in suitable memory means of the control unit 23. With the next approach to the loading station saved in this way, the respective mark can be called up by entering the respective loading station 13 and then displayed on the display screen 11. For example, with the help of an adjustment element 24 and a display device 25, it is possible to select the desired loading station 13, whose respective marks 12, 17 are then displayed on the display screen 11 to perform the approach to locate the loading position.

According to FIG. 5, the inventive commercial vehicle 1 may also be designed as a truck having a semi-trailer 26.

In a corresponding manner, the commercial vehicle 1 according to FIG. 6 may also be formed by a truck having a trailer 27. In this case, it is essentially possible for both the trailer 27 and the tractor vehicle to be equipped with a lifting loading platform 3. It is clear that with such an embodiment, the operating unit 4 located in the driver's cab 7 is automatically or manually reversible for operation of the lifting loading platform 3 assigned to the tractor machine or to the lifting loading platform 3 assigned to the trailer 27. If both the trailer 27 and the tractor machine are equipped with a rearview camera 8, here again measures are taken to permit arbitrary or automatic switching between the two cameras 8.

According to FIGS. 1, 5 and 6, the loading ramp 14 is expediently dimensioned such that the lifting loading platform 3 runs essentially horizontally in its ramp position when it rests on the end section 16 of the loading ramp 14.

According to FIG. 7, the inventive operating unit 4 has at least four switches, namely a first switch 28, a second switch 29, a third switch 30 and a fourth switch 31. The switches 28 through 31 are accommodated in the interior of the operating unit 4 and are therefore represented only with interrupted lines. The switches 28 through 31 serve to operate different functions of the lifting loading platform 3. The first switch 28 serves to pivot the lifting loading platform 3 up, i.e., operation of the first switch 28 prompts the lifting loading platform 3 to be pivoted upward. In contrast with that, by operation of the second switch 29, the lifting loading platform 3 is made to pivot into the closed position. A shared first hand lever 32 is provided for the first switch 28 and the second switch 29 so that the driver of the vehicle can optionally and/or alternately operate the first switch 28 or the second switch 29. For example, the first handle 32 is designed as a pivotable lever.

With the help of the third switch 30, the lifting loading platform 3 can be lowered into its open position in which it is pivoted upward. In contrast with that, operation of the fourth switch 31 causes the pivoted lifting loading platform 3 to be raised. Again for this pair of switches 30, 31 a shared second handle 33 is provided, making it possible to manually confirm the third switch 30 or the fourth switch 31 optionally or alternately. The second handle 32 is also expediently designed as a pivotable lever.

The operating devices of the two handles 32, 33 are represented by appropriate arrows in FIG. 7. By means of an interrupted double arrow between FIG. 7 and FIG. 8, the functional assignment of the first handle 32 and/or the first switch 28 and the second switch 29 for raising and/or pivoting the lifting loading platform are illustrated according to FIG. 8, in which the pivoting movements are also indicated by arrows. Accordingly, the functional correlation between the second handle 33 and/or the third switch 30 and the fourth switch 31 for raising and/or lowering the lifting loading platform 3 according to FIG. 9 is established by an interrupted double arrow between FIGS. 7 and 9, with the lifting movements in FIG. 9 being represented by a double arrow.

In the embodiment according to FIG. 7, the operating unit 4 is accommodated together with the display screen 11 in a shared housing 22. This means that the display screen 11 together with the operating unit 4 forms an integral unit. In another advantageous embodiment, the operating unit 4 may be integrated into or adapted to an interior paneling element of the driver's cab 7. For example, a dashboard, a central console or a headliner of a vehicle are suitable as the interior lining element for accommodating the operating element 4. Alternatively the operating unit 4 may also be installed as a separate component, in particular subsequently, at a suitable location in the driver's cab 7.

1. A commercial vehicle with or without a trailer or semi-trailer, comprising:
a lifting loading platform arranged on the rear end of the vehicle, operational with an operating unit,
with a rearview camera which is mounted on the rear end of the vehicle and sends an image of a monitoring space situated behind the rear end of the vehicle to a display screen which is set up in a driver's cab of the vehicle,
at least one mark is provided in or on the display screen, this mark being positioned in such a way that the vehicle has a predetermined loading position in the approach to a loading station assigned to the mark when a correspondence is achieved on the display screen between the mark and a predetermined corner or edge of the loading station facing the lifting loading platform,
wherein the operating unit of the lifting loading platform is arranged in the driver's cab,
the operating unit having a first switch which causes the lifting loading platform to be pivoted upward when the switch is operated,
the operating unit having a second switch which causes the lifting loading platform to be pivoted upward into a closed position when the switch is operated,
the operating unit having a third switch which causes the lifting loading platform which has been pivoted upward to be lowered when the switch is operated,
the operating unit having a fourth switch which causes the lifting loading platform that has been pivoted upward to be raised when the switch is operated.

2. The commercial vehicle according to claim 1, wherein the first switch and the second switch can be operated in alternation by means of a shared first handle.

3. The commercial vehicle according to claim 1, wherein
the third switch and the fourth switch can be operated in alternation by means of a shared second handle.

4. The commercial vehicle according to claim 1, wherein any
the operating unit is integrated into or installed in an interior paneling element.

5. The commercial vehicle according to claim 1, wherein the operating unit and the display screen are accommodated in a shared housing.

6. The commercial vehicle according to claim 1, wherein
two operating units are provided for operating the lifting loading platform, wherein one operating unit is arranged on the rear end of the vehicle with the lifting loading platform and the other operating unit is provided in the driver's cab.

7. The commercial vehicle according to claim 1, wherein
a mark is provided for a loading station which is designed as a loading ramp, wherein the edge is formed by an upper front edge of the loading ramp facing the lifting loading platform, wherein the respective loading position is selected so that the lifting loading platform can be reliably placed on an end section of the loading ramp having the front edge.

8. The commercial vehicle according to claim 7, wherein
at least one of the loading ramp and the lifting loading platform are designed with dimensions such that the lifting loading platform runs essentially horizontally when it comes to rest on the end section of the loading ramp.

9. The commercial vehicle according to claim 1, wherein
a mark is provided for a loading station which is designed as a ground-level loading area, whereby the corner or edge is formed by a lower edge of a border of the loading area which protrudes upward from the ground and faces the lifting loading platform, whereby the respective loading position is selected so that the lifting loading platform can be placed reliably on the loading surface in front of the border for loading and unloading.

10. The commercial vehicle according to claim 1, wherein
at least one mark is provided permanently or adjustably on a display screen housing.

11. The commercial vehicle according to claim 1, wherein
at least one mark is permanently or adjustably integrated into the image displayed on the display screen.

12. The commercial vehicle according to claim 1, wherein
a control unit is provided in which a respective mark is stored or can be stored for multiple different loading stations, whereby a stored mark can be located by input of the desired loading station and can be displayed on the display screen.

13. An operating unit for operation of a lifting loading platform of a commercial vehicle,
wherein the operating unit is designed for installation in a driver's cab of the commercial vehicle,
wherein the operating unit has a first switch which, when operated, causes the lifting loading platform to be raised,
wherein the operating unit has a second switch which when operated causes the lifting loading platform to be closed,
wherein the operating unit has a third switch which when operated causes the lifting loading platform that has been pivoted upward to be lowered,
wherein the operating unit has a fourth switch which when operated causes the lifting loading platform that has been pivoted upward to be raised.

14. (canceled)

15. The operating unit according to claim 13, wherein the first switch and the second switch can be operated in alternation by means of a shared first handle.

16. The operating unit according to claim 13, wherein the third switch and the fourth switch can be operated in alternation by means of a shared second handle.

17. The operating unit according to claim 13, wherein the operating unit is integrated into or installed in an interior paneling element of said cab.

18. The operating unit according to claim 13, wherein the operating unit and a display screen are accommodated in a shared housing.

19. The commercial vehicle according to claim 1, wherein the commercial vehicle is a truck.

20. The commercial vehicle according to claim 4, wherein the interior paneling element comprises at least one of a dashboard, a central console, and a headliner.
